(19) United States
(12) Patent Application Publication
(10) Pub. No.: US 2025/0192971 A1
(43) Pub. Date: Jun. 12, 2025

(54) RADIO-FREQUENCY MODULE AND COMMUNICATION DEVICE

(71) Applicant: Murata Manufacturing Co., Ltd., Nagaokakyo-shi (JP)

(72) Inventor: Masakazu MIZOKAMI, Nagaokakyo-shi (JP)

(73) Assignee: Murata Manufacturing Co., Ltd., Nagaokakyo-shi (JP)

(21) Appl. No.: 19/059,307

(22) Filed: Feb. 21, 2025

Related U.S. Application Data
(63) Continuation of application No. PCT/JP2023/025999, filed on Jul. 14, 2023.

(30) Foreign Application Priority Data
Aug. 25, 2022 (JP) 2022-133927

(51) Int. Cl. H04L 5/14; H04B 1/00; H04B 1/44

(52) U.S. Cl. CPC H04L 5/1461; H04B 1/0057; H04B 1/44

(57) ABSTRACT

A radio-frequency module includes a power amplifier configured to amplify a signal of a first band, a low-noise amplifier configured to amplify a signal of a second band, and an intermodulation distortion (IMD) suppression circuit coupled to the power amplifier, a power amplifier configured to amplify a signal of a third band, and the low-noise amplifier and configured to generate an IMD suppression signal that includes a frequency component of intermodulation distortion between the first band and the third band. The signal of the first band, the signal of the second band, and the signal of the third band are to be simultaneously transferred. The second band includes a frequency of the intermodulation distortion.

### CROSS REFERENCE TO RELATED APPLICATIONS

This is a continuation application of PCT/JP2023/025999, filed on Jul. 14, 2023, designating the United States of America, which is based on and claims priority to Japanese Patent Application No. JP 2022-133927 filed on Aug. 25, 2022. The entire contents of the above-identified applications, including the specifications, drawings and claims, are incorporated herein by reference in their entirety.

### TECHNICAL FIELD

The present disclosure relates to a radio-frequency module and a communication device.

### BACKGROUND ART

Patent Document 1 discloses a radio-frequency system (radio-frequency module) capable of simultaneously transferring signals across multiple bands. In the radio-frequency system (radio-frequency module) disclosed in Patent Document 1, multiple multiplexers are coupled to each other, either directly or via switches or diplexers. The multiple multiplexers are coupled to power amplifiers for amplifying transmit signals or low-noise amplifiers for amplifying receive signals.

### CITATION LIST

### Patent Document

Patent Document 1: Japanese Unexamined Patent Application Publication No. 2021-48594

### SUMMARY OF DISCLOSURE

### Technical Problem

In the radio-frequency module disclosed in Patent Document 1, for example, assuming transmit signals of two bands and receive signals of one band are simultaneously transferred (two uplinks and one downlink), the interference between the two kinds of transmit signals generates unwanted intermodulation distortion (IMD) signals. Assuming the frequencies of the unwanted intermodulation distortion signals are included in the receive-signal band, these unwanted signals can pass through the receive path that transfers the receive signals, acting as receive noise. This receive noise degrades the receive sensitivity.

The present disclosure has been made to address the above problem, and a feature thereof is to provide a radio-frequency module and a communication device in which the degradation of receive sensitivity due to intermodulation distortion of multiple transmit signals is suppressed.

### Solution to Problem

To achieve the feature described above, a radio-frequency module according to an aspect of the present disclosure includes a first power amplifier configured to amplify a signal of a first band, a first low-noise amplifier configured to amplify a signal of a second band, and an intermodulation distortion (IMD) suppression circuit coupled to the first power amplifier, a second power amplifier configured to amplify a signal of a third band, and the first low-noise amplifier, the IMD suppression circuit being configured to generate an IMD suppression signal that includes a frequency component of intermodulation distortion between the first band and the third band. The signal of the first band, the signal of the second band, and the signal of the third band are to be simultaneously transferred. The second band includes a frequency of the intermodulation distortion.

### Effects of Disclosure

The present disclosure provides a radio-frequency module and a communication device in which the degradation of receive sensitivity due to intermodulation distortion of multiple transmit signals is suppressed.

### BRIEF DESCRIPTION OF DRAWINGS

FIG. 1 is a circuit configuration diagram of a radio-frequency module and a communication device according to an embodiment.

FIG. 2 provides a schematic diagram illustrating an example of the frequency relationship between two transmit signals and an unwanted intermodulation distortion signal.

FIG. 3 is a circuit state diagram of the radio-frequency module according to the embodiment with two uplinks and one downlink.

FIG. 4 illustrates an example of a circuit configuration of an intermodulation distortion (IMD) suppression circuit according to the embodiment.

FIG. 5 is a circuit configuration diagram of a radio-frequency module and a communication device according to a first modification of the embodiment.

FIG. 6 is a circuit configuration diagram of a radio-frequency module and a communication device according to a second modification of the embodiment.

### DESCRIPTION OF EMBODIMENTS

Hereinafter, embodiments of the present disclosure will be described in detail. It should be noted that the embodiments described below provide comprehensive or specific examples. Specifics including numerical values, shapes, materials, constituent elements, arrangements of the constituent elements, and modes of connection given in the following embodiments are merely examples and are not intended to limit the present disclosure. Among the constituent elements in the following embodiments and modifications, constituent elements not recited in any of the independent claims are described as arbitrary constituent elements. The size or size ratio of the constituent elements illustrated in the drawings is not necessarily presented in an exact manner. Like reference symbols denote substantially like configuration elements in the drawings, and redundant descriptions thereof can be omitted or simplified.

In the present disclosure, words used to express relationships between elements, such as parallel and vertical, words used to express the shape of an element, such as rectangular, and numerical ranges do not necessarily denote the exact meanings but denote substantially the same meanings involving, for example, several percent differences.

In the present disclosure, the term “coupled” may be interpreted as a circuit element that is directly coupled to another circuit element by using a connection terminal and/or a wire line conductor and also that a circuit element is electrically coupled to another circuit element via still another circuit element. The expression “coupled between A and B” and the expression “coupled between A and B” mean that a circuit element is coupled to A and B in a path connecting A and B.

In the present disclosure, the term “path” refers to a transmission line formed by, for example, a wire line for transferring radio-frequency signals, an electrode directly coupled to the wire line, and a terminal directly coupled to the wire line or electrode.

In the present disclosure, the expression “a component A is provided in series in a path B” may be interpreted as both the signal input end and the signal output end of the component A are coupled to a wire line, an electrode, or a terminal that constitute the path B.

### Embodiment

### [1. Configuration of Radio-Frequency Module 1 and Communication Device 4]

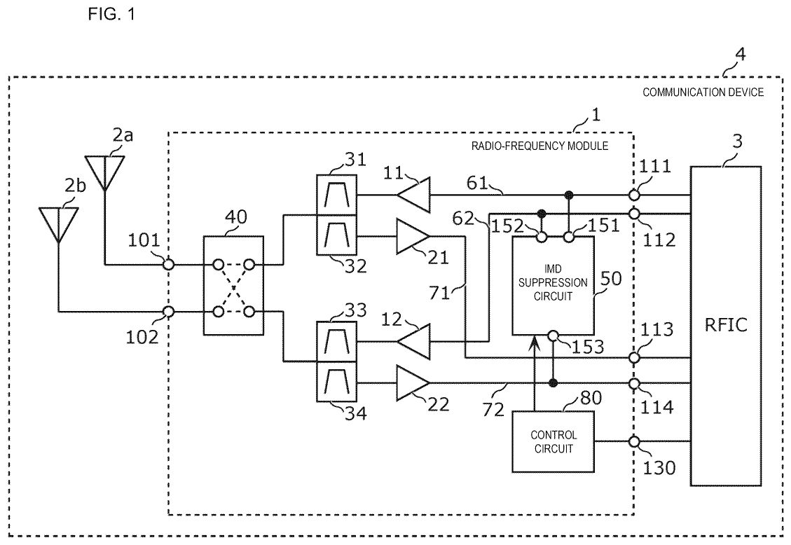

A circuit configuration of a radio-frequency module 1 and a communication device 4 incorporating the radio-frequency module 1 according to the present embodiment is described with reference to FIG. 1. FIG. 1 is a circuit configuration diagram of the radio-frequency module 1 and the communication device 4 according to the embodiment.

### 1.1 Circuit Configuration of Communication Device 4

The communication device 4 corresponds to a user equipment (UE) and is typically, for example, a mobile phone, smartphone, or tablet computer. The communication device 4 includes the radio-frequency module 1, antennas 2a and 2b, and a radio-frequency signal processing circuit (RFIC: radio frequency integrated circuit) 3.

The radio-frequency module 1 is operable to transfer radio-frequency signals between the antennas 2a and 2b and the RFIC 3. The circuit configuration of the radio-frequency module 1 will be described later.

The antenna 2a is coupled to an antenna connection terminal 101 of the radio-frequency module 1. The antenna 2b is coupled to an antenna connection terminal 102 of the radio-frequency module 1. The antennas 2a and 2b are operable to receive radio-frequency signals from the radio-frequency module 1 and output the radio-frequency signals to the outside.

The RFIC 3 is an example of a signal processing circuit for processing radio-frequency signals. Specifically, the RFIC 3 is operable to process, for example by up-conversion, a transmit signal inputted from a baseband signal processing circuit (BBIC: Baseband Integrated Circuit; not illustrated) and output the transmit signal generated by the signal processing to a transmit path in the radio-frequency module 1. The RFIC 3 is also operable to process, for example by down-conversion, a receive signal inputted through a receive path in the radio-frequency module 1 and output the receive signal generated by the signal processing to the BBIC.

The RFIC 3 is also operable to output control signals for controlling an intermodulation distortion (IMD) suppression circuit 50 and a switch 40, which are included in the radio-frequency module 1, to a control circuit 80 of the radio-frequency module 1. The control function of the RFIC 3 may be partially or entirely configured outside the RFIC 3; for example, the control function of the RFIC 3 may be partially or entirely configured in the BBIC or the radio-frequency module 1.

In the communication device 4 according to the present embodiment, the antennas 2a and 2b are optional constituent elements. Only one antenna may be included.

### 1.2 Circuit Configuration of Radio-Frequency Module 1

Next, a circuit configuration of the radio-frequency module 1 is described. As illustrated in FIG. 1, the radio-frequency module 1 includes power amplifiers 11 and 12, low-noise amplifiers 21 and 22, filters 31, 32, 33, and 34, the switch 40, the IMD suppression circuit 50, the control circuit 80, antenna connection terminals 101 and 102, signal input terminals 111 and 112, signal output terminals 113 and 114, and a control signal terminal 130.

The antenna connection terminal 101 is an example of a first antenna terminal. The antenna connection terminal 101 is coupled to the antenna 2a. The antenna connection terminal 102 is an example of a second antenna terminal. The antenna connection terminal 102 is coupled to the antenna 2b.

Each of the signal input terminals 111 and 112 is a terminal designed to receive, for example, 4th Generation (4G)-Long Term Evolution (LTE) or 5th Generation (5G)-New Radio (NR) transmit signals. The signal input terminal 111 is an example of a first transmit input terminal. The signal input terminal 111 is coupled to the RFIC 3 and the input end of the power amplifier 11. The signal input terminal 112 is an example of a second transmit input terminal. The signal input terminal 112 is coupled to the RFIC 3 and the input end of the power amplifier 12.

Each of the signal output terminals 113 and 114 is a terminal designed to output, for example, 4G-LTE or 5G-NR receive signals. The signal output terminal 113 is an example of a second receive output terminal. The signal output terminal 113 is coupled to the RFIC 3 and the output end of the low-noise amplifier 21. The signal output terminal 114 is an example of either one of a first receive output terminal and a second receive output terminal. The signal output terminal 114 is coupled to the RFIC 3 and the output end of the low-noise amplifier 22. The signal output terminal 113 is an example of the other of a first receive output terminal and a second receive output terminal. The signal output terminal 113 is coupled to the RFIC 3 and the output end of the low-noise amplifier 21.

The power amplifier 11 is an example of a first power amplifier. The power amplifier 11 is capable of amplifying transmit signals of a first band that are input from the signal input terminal 111. The power amplifier 11 is provided in a transmit path 61 (a first transmit path) connecting the signal input terminal 111 and the antenna connection terminals 101 and 102.

The power amplifier 12 is an example of a second power amplifier. The power amplifier 12 is capable of amplifying transmit signals of a third band that are input from the signal input terminal 112. The power amplifier 12 is provided in a transmit path 62 (a second transmit path) connecting the signal input terminal 112 and the antenna connection terminals 101 and 102.

The low-noise amplifier 21 is an example of a second low-noise amplifier. The low-noise amplifier 21 is capable of amplifying receive signals of a fourth band that are input from the antenna connection terminal 101 or 102. The low-noise amplifier 21 is provided in a receive path 71 connecting the signal output terminal 113 and the antenna connection terminals 101 and 102.

The low-noise amplifier 22 is an example of a first low-noise amplifier. The low-noise amplifier 22 is capable of amplifying receive signals of a second band that are input from the antenna connection terminal 101 or 102. The low-noise amplifier 22 is provided in a receive path 72 (a first receive path) connecting the signal output terminal 114 and the antenna connection terminals 101 and 102.

The amplifier transistors implementing the power amplifiers 11 and 12 and the low-noise amplifiers 21 and 22 may be bipolar transistors or, for example, Metal-Oxide-Semiconductor Field-Effect-Transistors (MOSFETs). The power amplifiers 11 and 12 may be integrated into a single chip. The low-noise amplifiers 21 and 22 may be integrated into a single chip.

First-band transmit signals, second-band receive signals, and third-band transmit signals can be simultaneously transferred.

The first band, the second band, and the third band are frequency bands for communication systems that are constructed using radio access technologies (RAT) defined by standards organizations (for example, 3GPP (registered trademark) and the Institute of Electrical and Electronics Engineers (IEEE)). Examples of the communication systems include a 5G-NR system, a 4G-LTE system, and a Wireless Local Area Network (WLAN) system. However, these examples should not be interpreted as limiting.

The first band and the third band correspond to frequency-division duplexing (FDD) uplink operating bands or time-division duplexing (TDD) bands. The second band corresponds to a FDD downlink operating band or TDD band.

An uplink operating band refers to a frequency range designated for uplink within the bands specified for FDD. A downlink operating band refers to a frequency range designated for downlink within the bands specified for FDD.

The filter 31 is an example of a first filter. The filter 31 has a pass band that includes the first band. The input end of the filter 31 is coupled to the output end of the power amplifier 11, and the output end of the filter 31 is coupleable to the antenna connection terminals 101 or 102 via the switch 40.

The filter 32 has a pass band that includes the fourth band. The input end of the filter 32 is coupleable to the antenna connection terminal 101 or 102 via the switch 40, and the output end of the filter 32 is coupled to the input end of the low-noise amplifier 21.

The filter 33 is an example of a third filter. The filter 33 has a pass band that includes the third band. The input end of the filter 33 is coupled to the output end of the power amplifier 12, and the output end of the filter 33 is coupleable to the antenna connection terminals 101 or 102 via the switch 40.

The filter 34 is an example of a second filter. The filter 34 has a pass band that includes the second band. The input end of the filter 34 is coupleable to the antenna connection terminal 101 or 102 via the switch 40, and the output end of the filter 34 is coupled to the input end of the low-noise amplifier 22.

The switch 40 is an example of a first switch. The switch 40 is coupled between the antenna connection terminals 101 and 102, and the power amplifiers 11 and 12 and the low-noise amplifiers 21 and 22. Specifically, the switch 40 has a first common terminal, a second common terminal, a first selection terminal, and a second selection terminal. The first common terminal is coupled to the antenna connection terminal 101, the second common terminal is coupled to the antenna connection terminal 102, the first selection terminal is coupled to the power amplifier 11 and the low-noise amplifier 21 via the filters 31 and 32, and the second selection terminal is coupled to the power amplifier 12 and the low-noise amplifier 22 via the filters 33 and 34. With this connection configuration, the switch 40 is operable to switch the connection of the antenna connection terminal 101 between the power amplifier 11 and the low-noise amplifier 21, and the power amplifier 12 and the low-noise amplifier 22; the switch 40 is also operable to switch the connection of the antenna connection terminal 102 between the power amplifier 11 and the low-noise amplifier 21, and the power amplifier 12 and the low-noise amplifier 22.

The switch 40 may switch between connecting and disconnecting the antenna connection terminal 101 to the power amplifier 11 and the low-noise amplifier 21, and connecting and disconnecting the antenna connection terminal 102 to the power amplifier 11 and the low-noise amplifier 21. This indicates that the switch 40 may connect the power amplifier 11 and the low-noise amplifier 21 exclusively to the antenna 2a among the antennas 2a and 2b, and the power amplifier 12 and the low-noise amplifier 22 exclusively to the antenna 2b among the antennas 2a and 2b.

The IMD suppression circuit 50 is coupled to the power amplifiers 11 and 12 and the low-noise amplifier 22. The IMD suppression circuit 50 is operable to generate IMD suppression signals that include IMD frequency components of the first band and the third band. The IMD suppression circuit 50 is not necessarily coupled directly to the power amplifiers 11 and 12, and the low-noise amplifier 22, but may instead be coupled to the transmit paths 61 and 62 and the receive path 72.

The second band includes the frequencies of unwanted intermodulation distortion signals generated by the interference between first-band transmit signals amplified by the power amplifier 11 and third-band transmit signals amplified by the power amplifier 12.

The IMD suppression circuit 50 receives first-band transmit signals propagating through the transmit path 61 and third-band transmit signals propagating through the transmit path 62, and generates an IMD suppression signal that is antiphase to the unwanted signal, which is an intermodulation distortion signal between the two kinds of transmit signals, propagating through the receive path 72.

In the radio-frequency module 1, in the case in which a first-band transmit signal (a first transmit signal), a third-band transmit signal (a second transmit signal), and a second-band receive signal are simultaneously transmitted, assuming the second band includes the frequencies of unwanted intermodulation distortion signals generated by the interference between the first transmit signal and the second transmit signal, the unwanted signals pass through the filter 34 and propagate through the receive path 72. Assuming the unwanted signals propagating through the receive path 72 are input to the RFIC 3, the receive sensitivity for second-band receive signals degrades.

Considering this, in the radio-frequency module 1, the IMD suppression circuit 50 generates an IMD suppression signal that is antiphase to the unwanted signal. The unwanted signal and the IMD suppression signal are then combined near the node between an output terminal 153 and the receive path 72. In this manner, unwanted signals propagating through the receive path 72 are suppressed. This configuration suppresses the degradation of receive sensitivity caused by intermodulation distortion between the first transmit signal and the second transmit signal.

The IMD suppression signals generated by the IMD suppression circuit 50 and the unwanted signals propagating through the receive path 72 are not necessarily phase-inverted relative to each other. It is sufficient that the amplitude of the unwanted signals combined with the IMD suppression signals near the node between the output terminal 153 and the receive path 72 is smaller than the amplitude of the unwanted signals before combined with the IMD suppression signals. To achieve this, it is sufficient for the phase difference between the IMD suppression signal and the unwanted signal to be approximately 120° to 180°. Assuming the phase difference is 170° to 190°, the improvement in the unwanted signal is approximately 20 dB, and assuming the phase difference is 160° to 200°, the improvement in the unwanted signal is approximately 9 dB.

Specifically, the IMD suppression circuit 50 includes an input terminal 151 (a first terminal) and an input terminal 152 (a second terminal), and the output terminal 153 (a third terminal). As illustrated in FIG. 1, it is desirable that the input terminal 151 is coupled to the input end of the power amplifier 11, the input terminal 152 is coupled to the input end of the power amplifier 12, and the output terminal 153 is coupled to the output end of the low-noise amplifier 22.

With this configuration, low-noise transmit signals before being amplified by the power amplifiers 11 and 12 are input to the IMD suppression circuit 50. As a result, the IMD suppression circuit 50 can generate highly accurate IMD suppression signals. Additionally, since the IMD suppression circuit 50 is coupled to the output end of the low-noise amplifier 22, the IMD suppression circuit 50 can highly accurately align the amplitude of the IMD suppression signal with the amplitude of the unwanted signal that is output from the low-noise amplifier 22. Consequently, the unwanted signals superimposed on the receive signals output from the radio-frequency module 1 can be suppressed with high accuracy.

The control circuit 80 is operable to control the IMD suppression circuit 50. The control circuit 80 controls the amplitude and phase of the IMD suppression signal generated by the IMD suppression circuit 50 based on the control signal that is input from the RFIC 3 through the control signal terminal 130. The control signal input from the RFIC 3 includes information corresponding to, for example, the combination of simultaneously transferred bands, frequency, and output power.

This configuration enables the radio-frequency module 1 to generate the IMD suppression signal using the IMD suppression circuit 50, aligning the IMD suppression signal with the unwanted IMD signal that varies depending on the combination of simultaneously transferred bands.

The control circuit 80 may control the switch 40 to coordinate the switching of the switch 40 with the IMD suppression circuit 50.

The output terminal 153 of the IMD suppression circuit 50 may be coupled to the low-noise amplifier 21. With this configuration, assuming the fourth band includes the frequency of the unwanted intermodulation distortion signal generated by the interference between first-band transmit signals amplified by the power amplifier 11 and third-band transmit signals amplified by the power amplifier 12, the IMD suppression circuit 50 suppresses the unwanted intermodulation distortion signals propagating through the receive path 71.

The filters 31 to 34, the switch 40, the low-noise amplifier 21, and the control circuit 80 are optional constituent elements for the radio-frequency module 1 according to the present embodiment.

### 1.3 Example of Unwanted IMD Signal Generation in Radio-Frequency Module 1

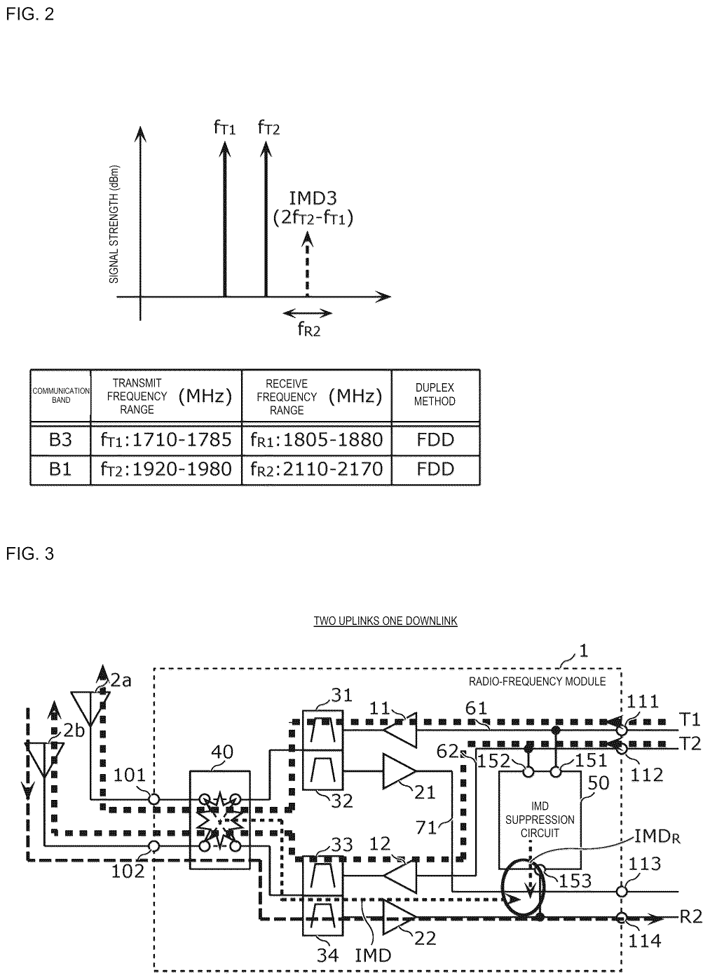

FIG. 2 provides a schematic diagram illustrating an example of the frequency relationship between two transmit signals and an unwanted IMD signal. The drawing illustrates the case in which third intermodulation distortion (IMD3) occurs in the radio-frequency module 1, assuming the transmit path 61 transfers the first transmit signal in the uplink operating band of 4G-LTE Band 3, the transmit path 62 transfers the second transmit signal in the uplink operating band of 4G-LTE Band 1, and the receive path 72 transfers the receive signal in the downlink operating band of 4G-LTE Band 1 (two uplinks and one downlink). In other words, FIG. 2 illustrates the case in which third intermodulation distortion (IMD3) occurs in the radio-frequency module 1, assuming the power amplifier 11 amplifies the first transmit signal in the uplink operating band of 4G-LTE Band 3, the power amplifier 12 amplifies the second transmit signal in the uplink operating band of 4G-LTE Band 1, and the low-noise amplifier 22 amplifies the receive signal in the downlink operating band of 4G-LTE Band 1 (two uplinks and one downlink).

The uplink operating band of 4G-LTE Band 3 is an example of the first band. The uplink operating band of 4G-LTE Band 1 is an example of the third band. The downlink operating band of 4G-LTE Band 1 is an example of the second band.

Assuming the strength of the first transmit signal output from the antenna connection terminal 101 is, for example, greater than or equal to 20 dBm, and the strength of the second transmit signal output from the antenna connection terminal 102 is, for example, greater than or equal to 20 dBm, the required strength of the first transmit signal at the output end of the power amplifier 11 and the required strength of the second transmit signal at the output end of the power amplifier 12 are greater than or equal to 23 dBm. Assuming the first transmit signal and the second transmit signal having the specified strength interfere with each other at any of the amplifiers, the filters, and the switch 40, unwanted intermodulation distortion signals are generated. Here, f_{T1} represents the frequency of the first transmit signal in 4G-LTE Band 3, f_{T2} represents the frequency of the second transmit signal in 4G-LTE Band 1, and f_{R2} represents the frequency of the receive signal in 4G-LTE Band 1. The frequency f_{R2} can include the frequency IMD3 (2×f_{T2}−f_{T1}).

The unwanted intermodulation distortion waves generated by mutual interference between the first transmit signal transferred through the transmit path 61 and the second transmit signal transferred through the transmit path 62 are not limited to third-order intermodulation distortion but may be second-order, fourth-order, or higher-order intermodulation distortion. Specifically, examples of the intermodulation distortion frequency based on two transmit signals (T1 and T2) typically include 2f_{T1}−f_{T2}, 2f_{T2}−f_{T1}, f_{T1}−f_{T2}, and f_{T2}−f_{T1}. However, this should not be interpreted as limiting, and frequencies specified by mf_{T1}+nf_{T2} and mf_{T2}+nf_{T1} (where m and n are natural numbers) are also included.

FIG. 3 is a circuit state diagram of the radio-frequency module 1 according to the embodiment with two uplinks and one downlink. The drawing illustrates signal flows in the radio-frequency module 1 assuming the first transmit signal amplified by the power amplifier 11, the second transmit signal amplified by the power amplifier 12, and the receive signal amplified by the low-noise amplifier 22 are simultaneously transferred (two uplinks and one downlink).

The first transmit signal T1 is output to the antenna 2a via the signal input terminal 111, the power amplifier 11, the filter 31, the switch 40, and the antenna connection terminal 101. The second transmit signal T2 is output to the antenna 2b via the signal input terminal 112, the power amplifier 12, the filter 33, the switch 40, and the antenna connection terminal 102. The receive signal R2 is output to the RFIC 3 via the antenna 2b, the antenna connection terminal 102, the switch 40, the filter 34, the low-noise amplifier 22, and the signal output terminal 114.

In this case, the first transmit signal T1 and the second transmit signal T2 interfere with each other at, for example, the switch 40, causing intermodulation distortion. Assuming the second band includes the frequency of this intermodulation distortion, the unwanted intermodulation distortion signal passes through the filter 34 and propagates through the receive path 72.

In response to this, the IMD suppression circuit 50 generates an IMD suppression signal antiphase to the unwanted signal based on the information about the first transmit signal T1 input from the transmit path 61 and the information about the second transmit signal T2 input from the transmit path 62. This generated IMD suppression signal and the unwanted signal are combined near the output terminal 153. As a result, the unwanted signal propagating through the receive path 72 is suppressed. In this manner, the degradation of receive sensitivity caused by intermodulation distortion between the first transmit signal T1 and the second transmit signal T2 is suppressed.

### 1.4 Specific Configuration of IMD Suppression Circuit 50

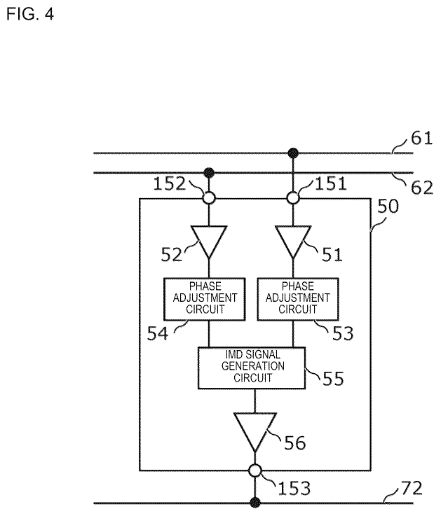

FIG. 4 illustrates an example of a circuit configuration of the IMD suppression circuit 50 according to the embodiment. As illustrated in the drawing, the IMD suppression circuit 50 includes the input terminals 151 and 152, the output terminal 153, an amplitude adjustment circuits 51, 52 and 56, phase adjustment circuits 53 and 54, and an IMD signal generation circuit 55.

The amplitude adjustment circuit 51 is an example of a first amplitude adjustment circuit. The amplitude adjustment circuit 51 is coupled to the input terminal 151. The amplitude adjustment circuit 51 is operable to adjust the amplitude of a portion of the first transmit signal input through the input terminal 151. The amplitude adjustment circuit 52 is an example of a second amplitude adjustment circuit. The amplitude adjustment circuit 52 is coupled to the input terminal 152. The amplitude adjustment circuit 52 is operable to adjust the amplitude of a portion of the second transmit signal input through the input terminal 152.

The amplitude adjustment circuits 51 and 52 are, for example, amplifiers. The amplitude adjustment circuits 51 and 52 may be variable gain amplifiers. With this configuration, the amplitudes of the signals output from the amplitude adjustment circuits 51 and 52 can be adjusted based on the band combination, frequencies, and amplitudes of the first transmit signal and the second transmit signal.

The phase adjustment circuit 53 is an example of a first phase adjustment circuit. The phase adjustment circuit 53 is coupled to the output end of the amplitude adjustment circuit 51. The phase adjustment circuit 53 is operable to adjust the phase of the signal output from the amplitude adjustment circuit 51. The phase adjustment circuit 54 is an example of a second phase adjustment circuit. The phase adjustment circuit 54 is coupled to the output end of the amplitude adjustment circuit 52. The phase adjustment circuit 54 is operable to adjust the phase of the signal output from the amplitude adjustment circuit 52.

The phase adjustment circuits 53 and 54 are, for example, phase shifters. The phase adjustment circuits 53 and 54 may be variable phase shifters. With this configuration, the phases of the signals output from the phase adjustment circuits 53 and 54 can be adjusted based on the band combination, frequencies, and amplitudes of the first transmit signal and the second transmit signal.

The amplitude adjustment circuit 51 and the phase adjustment circuit 53 may be coupled in reverse order. Specifically, the phase adjustment circuit 53 may be coupled to the input terminal 151, and the amplitude adjustment circuit 51 may be coupled to the output end of the phase adjustment circuit 53. The amplitude adjustment circuit 52 and the phase adjustment circuit 54 may be coupled in reverse order. Specifically, the phase adjustment circuit 54 may be coupled to the input terminal 152, and the amplitude adjustment circuit 52 may be coupled to the output end of the phase adjustment circuit 54.

The IMD signal generation circuit 55 is coupled to the output end of the phase adjustment circuit 53 and the output end of the phase adjustment circuit 54. The IMD signal generation circuit 55 generates an IMD suppression signal that is antiphase to the unwanted intermodulation distortion signal propagating through the receive path 72 at the output terminal 153. The IMD suppression signal includes the intermodulation distortion frequency component between the first band and the third band, based on the first-band signal that is output from the amplitude adjustment circuit 51 and the phase adjustment circuit 53 and the third-band signal that is output from the amplitude adjustment circuit 52 and the phase adjustment circuit 54.

The IMD signal generation circuit 55 is composed of, for example, frequency multiplier circuits and a mixer. The frequency multiplier circuits are provided, for example, respectively at the output end of the phase adjustment circuit 53 and the output end of the phase adjustment circuit 54. The frequency multiplier circuits output signals obtained by multiplying the frequencies of the signals output from the phase adjustment circuits 53 and 54, based on the mode of the IMD suppression signal to be generated. For example, to generate an IMD suppression signal at the frequency of IMD3 (2×f_{T2}−f_{T1}) described above, the frequency of the signal output from the phase adjustment circuit 53 is multiplied by 1, and the frequency of the signal output from the phase adjustment circuit 54 is multiplied by 2. The mixer is coupled to the output ends of the two frequency multiplier circuits. The mixer generates a signal with the difference frequency (or addition frequency) of the two signals output from the two frequency multiplier circuits. For example, to generate an IMD suppression signal at the frequency of IMD3 (2×f_{T2}−f_{T1}) described above, a signal with a frequency component of (2×f_{T2}−f_{T1}) is output as the output signal from the mixer.

The amplitude adjustment circuit 56 is an example of a third amplitude adjustment circuit. The amplitude adjustment circuit 56 is coupled between the IMD signal generation circuit 55 and the output terminal 153. The amplitude adjustment circuit 56 adjusts the amplitude of the IMD suppression signal generated by the IMD signal generation circuit 55.

The amplitude adjustment circuit 56 is, for example, an amplifier. The amplitude adjustment circuit 56 may be a variable gain amplifier. This configuration adjusts the amplitude of the IMD suppression signal generated by the IMD signal generation circuit 55 to suppress the unwanted signal propagating through the receive path 72, based on, for example, the band combination, frequencies, and amplitudes of the first transmit signal and the second transmit signal.

The amplitude adjustment circuit 56 is an optional constituent element for the IMD suppression circuit 50.

### 1.5 Circuit Configuration of Radio-Frequency Module 1A According to First Modification

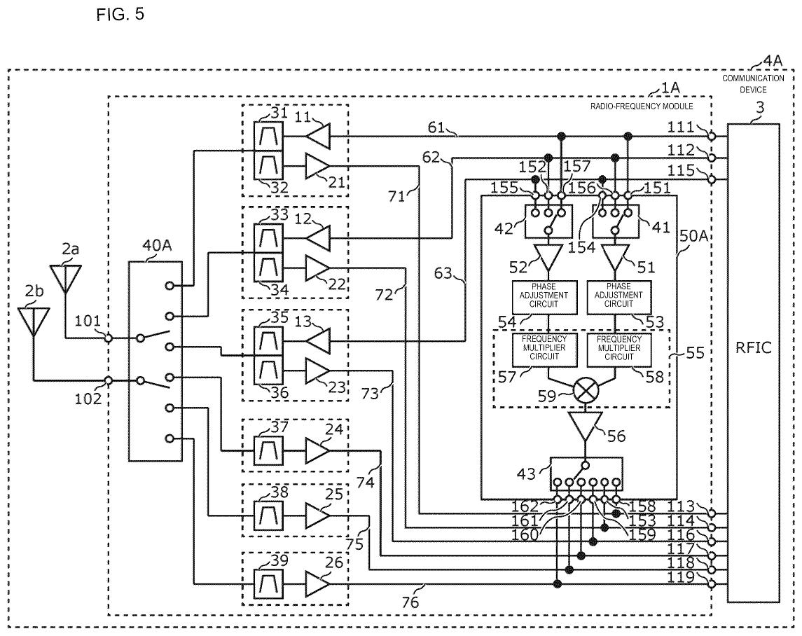

FIG. 5 is a circuit configuration diagram of a radio-frequency module 1A and a communication device 4A according to a first modification of the embodiment. As illustrated in the device, the communication device 4A includes the radio-frequency module 1A, antennas 2a and 2b, and an RFIC 3. The communication device 4A according to the present modification differs from the communication device 4 according to the embodiment in the circuit configuration of the radio-frequency module 1A. The following describes a configuration of the radio-frequency module 1A according to the present modification.

As illustrated in FIG. 5, the radio-frequency module 1A includes power amplifiers 11, 12, and 13, low-noise amplifiers 21, 22, 23, 24, 25, and 26, filters 31, 32, 33, 34, 35, 36, 37, 38, and 39, a switch 40A, an IMD suppression circuit 50A, antenna connection terminals 101 and 102, signal input terminals 111, 112, and 115, and signal output terminals 113, 114, 116, 117, 118, and 119.

The radio-frequency module 1A according to the present modification differs from the radio-frequency module 1 according to the embodiment in, for example, the number of provided power amplifiers, the number of provided low-noise amplifiers, and the circuit configuration of the IMD suppression circuit 50A. The following describes the radio-frequency module 1A according to the present modification with a main focus on configurational features different from the radio-frequency module 1 according to the embodiment, and descriptions of the same configurational features as the radio-frequency module 1 according to the embodiment will not be repeated. The control circuit 80 is not illustrated in the radio-frequency module 1A illustrated in FIG. 5. However, the control circuit 80 may be provided in the same manner as the radio-frequency module 1 according to the embodiment.

Each of the signal input terminals 111, 112, and 115 is a terminal designed to receive, for example, 4G-LTE or 5G-NR transmit signals. The signal input terminal 111 is coupled to the RFIC 3 and the input end of the power amplifier 11. The signal input terminal 112 is coupled to the RFIC 3 and the input end of the power amplifier 12. The signal input terminal 115 is coupled to the RFIC 3 and the input end of the power amplifier 13.

Each of the signal output terminals 113 to 114 and 116 to 119 is a terminal designed to output, for example, 4G-LTE or 5G-NR receive signals. The signal output terminal 113 is coupled to the RFIC 3 and the output end of the low-noise amplifier 21. The signal output terminal 114 is coupled to the RFIC 3 and the output end of the low-noise amplifier 22. The signal output terminal 116 is coupled to the RFIC 3 and the output end of the low-noise amplifier 23. The signal output terminal 117 is coupled to the RFIC 3 and the output end of the low-noise amplifier 24. The signal output terminal 118 is coupled to the RFIC 3 and the output end of the low-noise amplifier 25. The signal output terminal 119 is coupled to the RFIC 3 and the output end of the low-noise amplifier 26.

The power amplifier 11 is an example of a first power amplifier. The power amplifier 11 is capable of amplifying transmit signals of the first band that are input from the signal input terminal 111. The power amplifier 11 is provided in a transmit path 61 (a first transmit path) connecting the signal input terminal 111 and the antenna connection terminal 101 or 102.

The power amplifier 12 is an example of a second power amplifier. The power amplifier 12 is capable of amplifying transmit signals of the third band that are input from the signal input terminal 112. The power amplifier 12 is provided in a transmit path 62 (a second transmit path) connecting the signal input terminal 112 and the antenna connection terminal 101 or 102.

The power amplifier 13 is an example of a third power amplifier and a fourth power amplifier. The power amplifier 13 is capable of amplifying transmit signals of a fifth band that are input from the signal input terminal 115. The power amplifier 13 is provided in a transmit path 63 connecting the signal input terminal 115 and the antenna connection terminal 101 or 102.

The low-noise amplifier 21 is an example of a second low-noise amplifier. The low-noise amplifier 21 is capable of amplifying receive signals of a fourth band that are input from the antenna connection terminal 101 or 102. The low-noise amplifier 21 is provided in a receive path 71 connecting the signal output terminal 113 and the antenna connection terminal 101 or 102.

The low-noise amplifier 22 is an example of a first low-noise amplifier. The low-noise amplifier 22 is capable of amplifying receive signals of the second band that are input from the antenna connection terminal 101 or 102. The low-noise amplifier 22 is provided in a receive path 72 (a first receive path) connecting the signal output terminal 114 and the antenna connection terminal 101 or 102.

The low-noise amplifier 23 is capable of amplifying receive signals of a sixth band that are input from the antenna connection terminal 101 or 102. The low-noise amplifier 23 is provided in a receive path 73 connecting the signal output terminal 116 and the antenna connection terminal 101 or 102.

The low-noise amplifier 24 is capable of amplifying receive signals of a seventh band that are input from the antenna connection terminal 101 or 102. The low-noise amplifier 24 is provided in a receive path 74 connecting the signal output terminal 117 and the antenna connection terminal 101 or 102.

The low-noise amplifier 25 is capable of amplifying receive signals of an eighth band that are input from the antenna connection terminal 101 or 102. The low-noise amplifier 25 is provided in a receive path 75 connecting the signal output terminal 118 and the antenna connection terminal 101 or 102.

The low-noise amplifier 26 is capable of amplifying receive signals of a ninth band that are input from the antenna connection terminal 101 or 102. The low-noise amplifier 26 is provided in a receive path 76 connecting the signal output terminal 119 and the antenna connection terminal 101 or 102.

At least two of first-band, third-band, and fifth-band transmit signals and at least one of second-band, fourth-band, and sixth-band to ninth-band receive signals can be simultaneously transferred.

The filter 35 has a pass band that includes the fifth band. The input end of the filter 35 is coupled to the output end of the power amplifier 13, and the output end of the filter 35 is coupleable to the antenna connection terminals 101 or 102 via the switch 40A.

The filter 36 has a pass band that includes the sixth band. The input end of the filter 36 is coupleable to the antenna connection terminal 101 or 102 via the switch 40A, and the output end of the filter 36 is coupled to the input end of the low-noise amplifier 23.

The filter 37 has a pass band that includes the seventh band. The input end of the filter 37 is coupleable to the antenna connection terminal 101 or 102 via the switch 40A, and the output end of the filter 37 is coupled to the input end of the low-noise amplifier 24.

The filter 38 has a pass band that includes the eighth band. The input end of the filter 38 is coupleable to the antenna connection terminal 101 or 102 via the switch 40A, and the output end of the filter 38 is coupled to the input end of the low-noise amplifier 25.

The filter 39 has a pass band that includes the ninth band. The input end of the filter 39 is coupleable to the antenna connection terminal 101 or 102 via the switch 40A, and the output end of the filter 39 is coupled to the input end of the low-noise amplifier 26.

The seventh band may be the same band as the fourth band, the eighth band may be the same band as the second band, and the ninth band may be the same band as the sixth band. In this case, the circuit including the power amplifiers 11, 12, and 13 and the low-noise amplifiers 21, 22, and 23 may form a primary circuit (transceiver circuit), and the circuit including the low-noise amplifiers 24 to 26 may form a diversity circuit (receive circuit).

The switch 40A is an example of a first switch. The switch 40A is coupled between the antenna connection terminals 101 and 102, and the power amplifiers 11 to 13 and the low-noise amplifiers 21 to 26. Specifically, the switch 40A has a first common terminal, a second common terminal, first to sixth selection terminals. The first common terminal is coupled to the antenna connection terminal 101, the second common terminal is coupled to the antenna connection terminal 102, the first selection terminal is coupled to the power amplifier 11 and the low-noise amplifier 21, the second selection terminal is coupled to the power amplifier 12 and the low-noise amplifier 22, the third selection terminal is coupled to the power amplifier 13 and the low-noise amplifier 23, the fourth selection terminal is coupled to the low-noise amplifier 24, the fifth selection terminal is coupled to the low-noise amplifier 25, and the sixth selection terminal is coupled to the low-noise amplifier 26.

The IMD suppression circuit 50A is coupled to the power amplifiers 11, 12, 13 and the low-noise amplifiers 21 to 26. The IMD suppression circuit 50A is operable to generate IMD suppression signals that include IMD frequency components between two bands among the first band, the third band, and the fifth band. The IMD suppression circuit 50A is not necessarily coupled directly to the power amplifiers 11, 12, and 13, and the low-noise amplifiers 21 to 26, but may instead be coupled to the transmit paths 61, 62, and 63 and the receive paths 71 to 76.

One of the second band, the fourth band, and the sixth to ninth bands includes the frequency of the unwanted intermodulation distortion signal generated by the interference between two of the first-band transmit signal, the third-band transmit signal, and the fifth-band transmit signal amplified by the power amplifiers 11 to 13.

The IMD suppression circuit 50A receives two kinds of transmit signals among the transmit signals propagating through the transmit paths 61 to 63, and generates IMD suppression signals that are antiphase to the unwanted signals, which is intermodulation distortion signals between the two kinds of transmit signals, propagating through the receive paths 71 to 76.

The IMD suppression circuit 50A includes input terminals 151, 152, 154, 155, 156, and 157, output terminals 153, 158, 159, 160, 161, and 162, switches 41, 42, and 43, amplitude adjustment circuits 51, 52, and 56, phase adjustment circuits 53 and 54, and an IMD signal generation circuit 55.

The input terminal 151 is an example of a first terminal. The input terminal 152 is an example of a second terminal. The input terminal 154 is an example of a fourth terminal. The input terminal 155 is an example of a fifth terminal.

The input terminal 151 is coupled to the power amplifier 11 (and the transmit path 61). The input terminal 152 is coupled to the power amplifier 12 (and the transmit path 62). The input terminal 154 is coupled to the power amplifier 13 (and the transmit path 63). The input terminal 155 is coupled to the power amplifier 13 (and the transmit path 63). The input terminal 156 is coupled to the power amplifier 12 (and the transmit path 62). The input terminal 157 is coupled to the power amplifier 11 (and the transmit path 61).

The output terminal 153 is an example of a third terminal. The output terminal 158 is an example of a sixth terminal.

The output terminal 153 is coupled to the low-noise amplifier 22 (and the receive path 72). The output terminal 158 is coupled to the low-noise amplifier 21 (and the receive path 71). The output terminal 159 is coupled to the low-noise amplifier 23 (and the receive path 73). The output terminal 160 is coupled to the low-noise amplifier 24 (and the receive path 74). The output terminal 161 is coupled to the low-noise amplifier 25 (and the receive path 75). The output terminal 162 is coupled to the low-noise amplifier 26 (and the receive path 76).

The switch 41 is an example of a second switch. The switch 41 is coupled between the input terminals 151, 154, and 156 and the amplitude adjustment circuit 51. The switch 41 is operable to switch the connection of the amplitude adjustment circuit 51 selectively between the input terminals 151, 154, and 156.

The switch 42 is an example of a third switch. The switch 42 is coupled between the input terminals 152, 155, and 157 and the amplitude adjustment circuit 52. The switch 42 is operable to switch the connection of the amplitude adjustment circuit 52 selectively between the input terminals 152, 155, and 157.

The amplitude adjustment circuit 51 is an example of a first amplitude adjustment circuit. The amplitude adjustment circuit 51 is coupleable to the input terminals 151, 154, and 156 via the switch 41. The amplitude adjustment circuit 51 is operable to adjust the amplitude of a portion of the transmit signal input through one of the input terminals 151, 154, and 156. The amplitude adjustment circuit 52 is an example of a second amplitude adjustment circuit. The amplitude adjustment circuit 52 is coupleable to the input terminals 152, 155, and 157 via the switch 42. The amplitude adjustment circuit 52 is operable to adjust the amplitude of a portion of the transmit signal input through one of the input terminals 152, 155, and 157.

The amplitude adjustment circuits 51 and 52 are, for example, amplifiers. The amplitude adjustment circuits 51 and 52 may be variable gain amplifiers. With this configuration, the amplitudes of the signals output from the amplitude adjustment circuits 51 and 52 can be adjusted based on the band combination, frequencies, and amplitudes of two kinds of transmit signals that are input from the input terminals of the IMD suppression circuit 50A.

The phase adjustment circuit 53 is an example of a first phase adjustment circuit. The phase adjustment circuit 53 is coupled to the output end of the amplitude adjustment circuit 51. The phase adjustment circuit 53 is operable to adjust the phase of the signal output from the amplitude adjustment circuit 51. The phase adjustment circuit 54 is an example of a second phase adjustment circuit. The phase adjustment circuit 54 is coupled to the output end of the amplitude adjustment circuit 52. The phase adjustment circuit 54 is operable to adjust the phase of the signal output from the amplitude adjustment circuit 52.

The phase adjustment circuits 53 and 54 are, for example, phase shifters. The phase adjustment circuits 53 and 54 may be variable phase shifters. With this configuration, the phases of the signals output from the phase adjustment circuits 53 and 54 can be adjusted based on the band combination, frequencies, and amplitudes of the two kinds of transmit signals.

The amplitude adjustment circuit 51 and the phase adjustment circuit 53 may be coupled in reverse order. Specifically, the phase adjustment circuit 53 may be coupled to the switch 41, and the amplitude adjustment circuit 51 may be coupled to the output end of the phase adjustment circuit 53. The amplitude adjustment circuit 52 and the phase adjustment circuit 54 may be coupled in reverse order. Specifically, the phase adjustment circuit 54 may be coupled to the switch 42, and the amplitude adjustment circuit 52 may be coupled to the output end of the phase adjustment circuit 54.

The IMD signal generation circuit 55 is coupled to the output end of the phase adjustment circuit 53 and the output end of the phase adjustment circuit 54. The IMD signal generation circuit 55 generates an IMD suppression signal that is antiphase to the unwanted intermodulation distortion signal propagating through one of the receive paths 71 to 76 at the output terminal 153 and 158 to 162. The IMD suppression signal includes the intermodulation distortion frequency component between two kinds of signals. The IMD suppression signal is generated based on the two kinds of signals: one signal selected from the first-band signal, the third-band signal, and the fifth-band signal, output from the amplitude adjustment circuit 51 and the phase adjustment circuit 53; and another signal selected from the first-band signal, the third-band signal, and the fifth-band signal, output from the amplitude adjustment circuit 52 and the phase adjustment circuit 54, which is different from the one signal output from the amplitude adjustment circuit 51 and the phase adjustment circuit 53.

The IMD signal generation circuit 55 is composed of, for example, frequency multiplier circuits 57 and 58 and a mixer 59.

The amplitude adjustment circuit 56 is an example of a third amplitude adjustment circuit. The amplitude adjustment circuit 56 is coupled between the IMD signal generation circuit 55 and the switch 43. The amplitude adjustment circuit 56 adjusts the amplitude of the IMD suppression signal generated by the IMD signal generation circuit 55.

The amplitude adjustment circuit 56 is, for example, an amplifier. The amplitude adjustment circuit 56 may be a variable gain amplifier. This configuration adjusts the IMD suppression signal generated by the IMD signal generation circuit 55 to suppress the unwanted signal propagating through one of the receive paths 71 to 76, based on, for example, the band combination, frequencies, and amplitudes of two kinds of transmit signals input from the input terminals.

The amplitude adjustment circuit 56 is an optional constituent element for the IMD suppression circuit 50A.

The switch 43 is an example of a fourth switch. The switch 43 is coupled between the output terminals 153 and 158 to 162 and the IMD signal generation circuit 55 (and the amplitude adjustment circuit 56). The switch 43 is operable to switch the connection of the IMD signal generation circuit 55 (and the amplitude adjustment circuit 56) selectively between the output terminals 153 and 158 to 162.

With the configuration described above, the IMD suppression circuit 50A generates an IMD suppression signal having a phase different from an unwanted intermodulation distortion signal generated by the simultaneous transfer of two kinds of transmit signals among the transmit signals amplified by the power amplifiers 11 to 13. The IMD suppression signal includes the frequency component of the unwanted intermodulation distortion signal.

With the configuration of the radio-frequency module 1A described above, the IMD suppression circuit 50A generates an IMD suppression signal that is antiphase to the unwanted signal. The unwanted signal and the IMD suppression signal are then combined near any of the output terminals 153 and 158 to 162. In this manner, unwanted signals propagating through any of the receive paths 71 to 76 are suppressed. This configuration suppresses the degradation of receive sensitivity caused by intermodulation distortion between two kinds of transmit signals of different frequencies.

Furthermore, the radio-frequency module 1A can change the frequency, amplitude, and phase of the IMD suppression signal of the IMD suppression circuit 50A by controlling the switches 41 to 43 of the IMD suppression circuit 50A, aligning the IMD suppression signal with the unwanted IMD signal that varies depending on the combination of simultaneously transferred bands.

The filters 31 to 39 and the switch 40A are optional constituent elements for the radio-frequency module 1A according to the present modification.

The radio-frequency module 1A may include four or more power amplifiers. In this case, one of the input terminals 154 and 155 of the IMD suppression circuit 50A may be coupled to the power amplifier 13 (a third power amplifier), and the other of the input terminals 154 and 155 may be coupled to a fourth power amplifier.

It may be possible that the input terminals 156 and 157 of the IMD suppression circuit 50A are not provided; it is sufficient that at least two of the output terminals 153 and 158 to 162 are provided.

It may be possible that the radio-frequency module 1A does not include six low-noise amplifiers; it is sufficient that the radio-frequency module 1A includes two or more low-noise amplifiers.

The radio-frequency module 1A may include multiple IMD suppression circuits. For example, of the first IMD suppression circuit among the multiple IMD suppression circuits, the input terminals are coupled to the power amplifiers 11 and 12, and the output terminal is coupled to the low-noise amplifier 22. Of the second IMD suppression circuit among the multiple IMD suppression circuits, the input terminals are coupled to the power amplifiers 12 and 13, and the output terminal is coupled to the low-noise amplifier 23. Of the third IMD suppression circuit among the multiple IMD suppression circuits, the input terminals are coupled to the power amplifiers 11 and 13, and the output terminal is coupled to the low-noise amplifier 21.

With this configuration, the radio-frequency module 1A can change the frequency, amplitude, and phase of the IMD suppression signal by selecting a specific IMD suppression circuit, aligning the IMD suppression signal with the unwanted IMD signal that varies depending on the combination of simultaneously transferred bands.

### 1.6 Circuit Configuration of Radio-Frequency Module 1B According to Second Modification

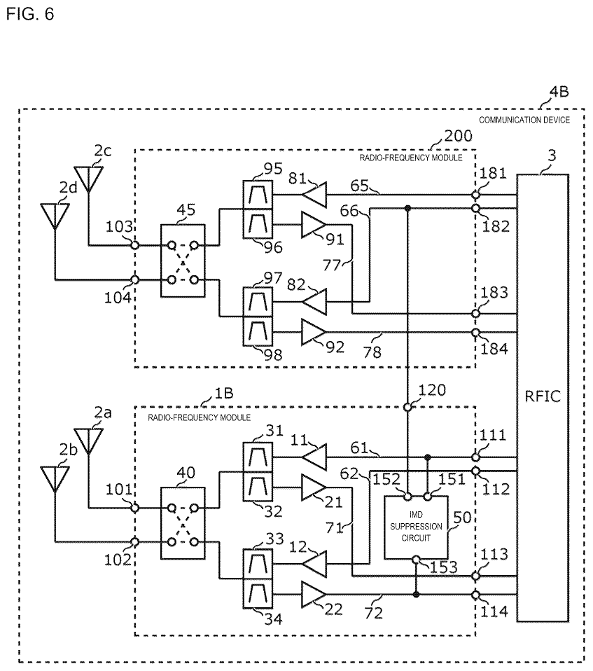

FIG. 6 is a circuit configuration diagram of a radio-frequency module 1B and a communication device 4B according to a second modification of the embodiment. As illustrated in the device, the communication device 4B includes the radio-frequency module 1B and a radio-frequency module 200, antennas 2a, 2b, 2c, and 2d, and an RFIC 3. The communication device 4B according to the present modification differs from the communication device 4 according to the embodiment in that the radio-frequency module 1B has a different configuration and that the radio-frequency modules 1B and 200 are included. The following describes a configuration of the radio-frequency modules 1B and 200 according to the present modification.

As illustrated in FIG. 6, the radio-frequency module 1B includes power amplifiers 11 and 12, low-noise amplifiers 21 and 22, filters 31, 32, 33, and 34, a switch 40, an IMD suppression circuit 50, antenna connection terminals 101 and 102, signal input terminals 111 and 112, and signal output terminals 113 and 114.

The radio-frequency module 200 includes power amplifiers 81 and 82, low-noise amplifiers 91 and 92, filters 95, 96, 97, and 98, a switch 45, antenna connection terminals 103 and 104, signal input terminals 181 and 182, and signal output terminals 183 and 184.

The radio-frequency module 1B according to the present modification differs from the radio-frequency module 1 according to the embodiment in the connection configuration of the IMD suppression circuit 50. The following describes the radio-frequency module 1B according to the present modification with a main focus on configurational features different from the radio-frequency module 1 according to the embodiment, and descriptions of the same configurational features as the radio-frequency module 1 according to the embodiment will not be repeated. The control circuit 80 is not illustrated in the radio-frequency module 1B illustrated in FIG. 6. However, the control circuit 80 may be provided in the radio-frequency module 1B, similar to the radio-frequency module 1 according to the embodiment.

The radio-frequency module 200 according to the present modification differs from the radio-frequency module 1 according to the embodiment in that the IMD suppression circuit 50 is not included. In the following, the configuration of the radio-frequency module 200 according to the present modification is omitted.

The power amplifier 11 is an example of a first power amplifier. The power amplifier 11 is capable of amplifying transmit signals of the first band that are input from the signal input terminal 111. The power amplifier 11 is provided in a transmit path 61 (a first transmit path) connecting the signal input terminal 111 and the antenna connection terminal 101.

The power amplifier 12 is capable of amplifying transmit signals that are input from the signal input terminal 112. The power amplifier 12 is provided in a transmit path 62 connecting the signal input terminal 112 and the antenna connection terminal 102.

The low-noise amplifier 21 is an example of a second low-noise amplifier. The low-noise amplifier 21 is capable of amplifying receive signals of a fourth band that are input from the antenna connection terminal 101 or 102. The low-noise amplifier 21 is provided in a receive path 71 connecting the signal output terminal 113 and the antenna connection terminal 101.

The low-noise amplifier 22 is an example of a first low-noise amplifier. The low-noise amplifier 22 is capable of amplifying receive signals of the second band that are input from the antenna connection terminal 101 or 102. The low-noise amplifier 22 is provided in a receive path 72 (a first receive path) connecting the signal output terminal 114 and the antenna connection terminal 102.

The power amplifier 81 is capable of amplifying transmit signals that are input from the signal input terminal 181. The power amplifier 81 is provided in a transmit path 65 connecting the signal input terminal 181 and the antenna connection terminal 103.

The power amplifier 82 is an example of a second power amplifier. The power amplifier 82 is capable of amplifying transmit signals of the third band that are input from the signal input terminal 182. The power amplifier 12 is provided in a transmit path 66 (a second transmit path) connecting the signal input terminal 182 and the antenna connection terminal 104.

The low-noise amplifier 91 is capable of amplifying receive signals that are input from the antenna connection terminal 103 or 104. The low-noise amplifier 91 is provided in a receive path 77 connecting the signal output terminal 183 and the antenna connection terminal 103.

The low-noise amplifier 92 is capable of amplifying receive signals that are input from the antenna connection terminal 103 or 104. The low-noise amplifier 92 is provided in a receive path 78 connecting the signal output terminal 184 and the antenna connection terminal 104.

First-band transmit signals transferred in the radio-frequency module 1B, second-band receive signals transferred the radio-frequency module 1B, and third-band transmit signals transferred in the radio-frequency module 200 can be simultaneously transferred.

The IMD suppression circuit 50 is coupled to the power amplifiers 11 and 82 and the low-noise amplifier 22. The IMD suppression circuit 50 is operable to generate IMD suppression signals that include IMD frequency components of the first band and the third band. The IMD suppression circuit 50 is not necessarily coupled directly to the power amplifiers 11 and 82, and the low-noise amplifier 22, but may instead be coupled to the transmit paths 61 and 66 and the receive path 72. Specifically, the IMD suppression circuit 50 includes an input terminal 151 (a first terminal) and an input terminal 152 (a second terminal), and the output terminal 153 (a third terminal). The input terminal 151 is coupled to the input end of the power amplifier 11, the input terminal 152 is coupled to the input end of the power amplifier 82 via an external connection terminal 120, and the output terminal 153 is coupled to the output end of the low-noise amplifier 22. In other words, the IMD suppression circuit 50 according to the present modification is coupled to the power amplifier 11 of the radio-frequency module 1B and the power amplifier 82 of the radio-frequency module 200.

The second band includes the frequencies of unwanted intermodulation distortion signals generated by the interference between first-band transmit signals amplified by the power amplifier 11 and third-band transmit signals amplified by the power amplifier 82.

The IMD suppression circuit 50 receives first-band transmit signals propagating through the transmit path 61 and third-band transmit signals propagating through the transmit path 66, and generates an IMD suppression signal that is antiphase to the unwanted signal, which is an intermodulation distortion signal between the two kinds of transmit signals, propagating through the receive path 72.

With this configuration, in the radio-frequency module 1B, the IMD suppression circuit 50 generates an IMD suppression signal that is antiphase to the unwanted signal. The unwanted signal and the IMD suppression signal are then combined near the output terminal 153. In this manner, unwanted signals propagating through the receive path 72 are suppressed. This configuration suppresses the degradation of receive sensitivity caused by intermodulation distortion between the first transmit signal and the second transmit signal.

In the radio-frequency module 1B, the filters 31 to 34, the switch 40, the power amplifier 12, and the low-noise amplifier 21 are optional constituent elements for the radio-frequency module 1B according to the present modification.

It may be possible that the communication device 4B according to the present modification does not include the radio-frequency module 200, and the antennas 2c and 2d.

### 2. Effects

As described above, the radio-frequency module 1 according to the present embodiment and the radio-frequency module 1B according to the second modification include the power amplifier 11 configured to amplify a signal of the first band, the low-noise amplifier 22 configured to amplify a signal of the second band, and the IMD suppression circuit 50 coupled to the power amplifier 11, the power amplifier 12 configured to amplify a signal of the third band, and the low-noise amplifier 22 and configured to generate an IMD suppression signal that includes the frequency component of intermodulation distortion between the first band and the third band. The signal of the first band, the signal of the second band, and the signal of the third band are to be simultaneously transferred. The second band includes the frequency of the intermodulation distortion.

With this configuration, the IMD suppression signal generated by the IMD suppression circuit 50 suppresses the unwanted signal of intermodulation distortion between the first transmit signal of the first band and the second transmit signal of the third band, passing through the low-noise amplifier 22. This configuration suppresses the degradation of receive sensitivity caused by intermodulation distortion between the first transmit signal and the second transmit signal.

In an example, in the radio-frequency modules 1 and 1B, the IMD suppression circuit 50 may be coupled to the input end of the power amplifier 11, the input end of the power amplifier 12, and the output end of the low-noise amplifier 22.

With this configuration, low-noise transmit signals before being amplified by the power amplifiers 11 and 12 are input to the IMD suppression circuit 50. As a result, highly accurate IMD suppression signals can be generated. Furthermore, since the IMD suppression circuit 50 is coupled to the output end of the low-noise amplifier 22, unwanted signals, which can otherwise be superimposed on the receive signals output from the radio-frequency module 1, are suppressed with high accuracy.

In an example, the radio-frequency module 1 may further include the power amplifier 12, the antenna connection terminals 101 and 102, the signal input terminals 111 and 112, and the signal output terminal 114. The power amplifier 11 may be provided in the transmit path 61 connecting the signal input terminal 111 and the antenna connection terminal 101. The power amplifier 12 may be provided in the transmit path 62 connecting the signal input terminal 112 and the antenna connection terminal 102. The low-noise amplifier 22 may be provided in the receive path 72 connecting the signal output terminal 114 and the antenna connection terminal 101 or 102. The IMD suppression circuit 50 may be coupled to the transmit paths 61 and 62 and the receive path 72. The IMD suppression circuit 50 may be configured to generate an IMD suppression signal that includes the frequency component of the unwanted signal of the intermodulation distortion and that has a phase different from the unwanted signal propagating through the receive path 72.

With this configuration, in the radio-frequency module 1, the IMD suppression circuit 50 generates an IMD suppression signal that is antiphase to the unwanted signal. The unwanted signal and the IMD suppression signal are then combined near the node between the IMD suppression circuit 50 and the receive path 72. In this manner, unwanted signals propagating through the receive path 72 are suppressed. This configuration suppresses the degradation of receive sensitivity caused by intermodulation distortion between the first transmit signal and the second transmit signal.

In an example, the radio-frequency module 1 may further include the filter 31 coupled between the antenna connection terminal 101 and the power amplifier 11, having a pass band that includes the first band, the filter 34 coupled between the antenna connection terminal 101 or 102 and the low-noise amplifier 22, having a pass band that includes the second band, and the filter 33 coupled between the antenna connection terminal 102 and the power amplifier 12, having a pass band that includes the third band.

With this configuration, noises in the first transmit signal transferred through the transmit path 61, the second transmit signal transferred through the transmit path 62, and the receive signal transferred through the receive path 72 can be reduced.

In an example, the radio-frequency module 1 may further include the switch 40 coupled between the antenna connection terminals 101 and 102, and the power amplifiers 11 and 12 and the low-noise amplifier 22.

With this configuration, it is possible to switch the connections between the antenna connection terminals 101 and 102, and the power amplifiers 11 and 12 and the low-noise amplifier 22, depending on whether the first-band signal, the second-band signal, or the third-band signal is to be transferred.

In an example, in the radio-frequency modules 1 and 1B, the IMD suppression circuit 50 may include the input terminal 151 coupled to the power amplifier 11, the input terminal 152 coupled to the power amplifier 12, and the output terminal 153 coupled to the low-noise amplifier 22, the amplitude adjustment circuit 51 coupled to the input terminal 151, the amplitude adjustment circuit 52 coupled to the input terminal 152, the phase adjustment circuit 53 coupled to the amplitude adjustment circuit 51, the phase adjustment circuit 54 coupled to the amplitude adjustment circuit 52, and the IMD signal generation circuit 55 coupled to the phase adjustment circuits 53 and 54 and configured to generate the IMD suppression signal.

With this configuration, the IMD suppression circuit 50 generates an IMD suppression signal that corresponds to the power amplitudes and phases of the first transmit signal and the second transmit signal.

In an example, in the radio-frequency module 1A according to the first modification, as compared to the IMD suppression circuit 50, the IMD suppression circuit 50A may further include the input terminals 154 and 155, the switch 41 coupled between the input terminals 151 and 154 and the amplitude adjustment circuit 51 and configured to switch the connection of the amplitude adjustment circuit 51 between the input terminals 151 and 154, and the switch 42 coupled between the input terminals 152 and 155 and the amplitude adjusting circuit 52 and configured to switch the connection of the amplitude adjusting circuit 52 between the input terminals 152 and 155. The input terminal 154 may be coupled to the power amplifier 13. The input terminal 155 may be coupled to the power amplifier 13. The IMD suppression circuit 50A may be configured to generate an IMD suppression signal that includes the frequency component of the unwanted signal of intermodulation distortion generated by simultaneous transfer of two transmit signals among the first transmit signal amplified by the power amplifier 11, the second transmit signal amplified by the power amplifier 12, and the third transmit signal amplified by the power amplifier 13.

With this configuration, in the IMD suppression circuit 50A, the transmit path to be coupled to the IMD suppression circuit 50A can be selected by controlling the switches 41 and 42. As a result, an IMD suppression signal can be generated to correspond to the combination of signals of two bands transferred simultaneously.

In an example, the radio-frequency module 1A according to the first modification may further include the low-noise amplifier 21. The IMD suppression circuit may further include the output terminal 158, and the switch 43 coupled between the output terminals 153 and 158 and the IMD signal generation circuit 55 and configured to switch the connection of the IMD signal generation circuit 55 between the output terminals 153 and 158. The output terminal 158 may be coupled to the low noise amplifier 21. The IMD suppression circuit 50A may be configured to generate an IMD suppression signal that includes the frequency component of the unwanted signal of intermodulation distortion propagating through the low-noise amplifier 21 or 22 and that has a phase different from the unwanted signal.

With this configuration, the IMD suppression circuit 50A generates an IMD suppression signal that corresponds to the combination of signals of two bands transferred simultaneously, and the unwanted signal and the IMD suppression signal are combined near either the output terminal 153 or 158, depending on switching of the switch 43. As a result, this configuration suppresses the unwanted signal propagating through either the receive path 71 or 72. This configuration suppresses the degradation of receive sensitivity caused by intermodulation distortion between two kinds of transmit signals of different frequencies.

In an example, in the radio-frequency modules 1, 1A, and 1B, the IMD suppression circuit 50 (or 50A) may further include the amplitude adjustment circuit 56 coupled between the IMD signal generation circuit 55 and the output terminal 153.

This configuration adjusts the amplitude of the IMD suppression signal generated by the IMD signal generation circuit 55 to suppress the unwanted signal propagating through any of the receive paths, based on, for example, the band combination, frequencies, and amplitudes of two kinds of transmit signals input from the input terminals.

In an example, the radio-frequency modules 1, 1A, and 1B may further include the control circuit 80 configured to control the IMD suppression circuit 50 (or 50A).

With this configuration, the control circuit 80 outputs a control signal to the IMD suppression circuit 50 (or 50 A) based on information such as the combination of simultaneously transferred bands. As a result, this configuration generates the IMD suppression signal with high accuracy.

The communication device 4 according to the present embodiment includes the radio-frequency module 1 and the RFIC 3 configured to process a radio-frequency signal received or to be transmitted by the radio-frequency module 1.

This configuration enables the communication device 4 to achieve the effects of the radio-frequency module 1.

### OTHER EMBODIMENTS

The radio-frequency module and the communication device according to an embodiment of the present disclosure have been described by using the embodiment and modification, but the radio-frequency module and the communication device according to the present disclosure are not limited to the embodiment and modification. The present disclosure also embraces other embodiments implemented as any combination of the constituent elements of the embodiment and modification, other modifications obtained by making various modifications to the embodiment that occur to those skilled in the art without departing from the scope of the present disclosure, and various hardware devices including the radio-frequency module or the communication device according to the present disclosure.

For example, in the radio-frequency module and the communication device according to the embodiment and modification described above, other circuit elements and wire lines may be inserted in the paths connecting the circuit elements and signal paths that are illustrated in the drawings.

In the embodiment and the modifications, an example configuration is described in which two different bands can be simultaneously used. However, the configuration of the radio-frequency module and the communication device according to the present disclosure can be applied to configurations in which three or more different bands can be simultaneously used. In other words, the present disclosure also encompasses radio-frequency modules or communication devices having configurations that allow three or more different bands to be simultaneously used, in which the configurations correspond to the configurations of the radio-frequency module or the communication device according to the embodiment and the modifications described above.

The following describes the features of the radio-frequency module and the communication device explained based on the embodiment and the modifications.
<1>

A radio-frequency module comprising:
a first power amplifier configured to amplify a signal of a first band;
a first low-noise amplifier configured to amplify a signal of a second band; and
an intermodulation distortion (IMD) suppression circuit coupled to the first power amplifier, a second power amplifier configured to amplify a signal of a third band, and the first low-noise amplifier, the IMD suppression circuit being configured to generate an IMD suppression signal that includes a frequency component of intermodulation distortion between the first band and the third band, wherein
the signal of the first band, the signal of the second band, and the signal of the third band are to be simultaneously transferred, and
the second band includes a frequency of the intermodulation distortion.
<2>

The radio-frequency module according to <1>, wherein the IMD suppression circuit is coupled to an input end of the first power amplifier, an input end of the second power amplifier, and an output end of the first low-noise amplifier.
<3>

The radio-frequency module according to <1> or <2>, further comprising:
the second power amplifier; and
a first antenna terminal, a second antenna terminal, a first transmit input terminal, a second transmit input terminal, and a first receive output terminal, wherein
the first power amplifier is provided in a first transmit path connecting the first transmit input terminal and the first antenna terminal,
the second power amplifier is provided in a second transmit path connecting the second transmit input terminal and the second antenna terminal,
the first low-noise amplifier is provided in a first receive path connecting the first receive output terminal and the first antenna terminal or the second antenna terminal, and
the IMD suppression circuit is coupled to the first transmit path, the second transmit path, and the first receive path, and the IMD suppression circuit is configured to generate the IMD suppression signal that includes the frequency component of the intermodulation distortion, the IMD suppression signal having a phase different from an unwanted signal of the intermodulation distortion, the unwanted signal propagating through the first receive path.
<4>

The radio-frequency module according to <3>, further comprising:
a first filter coupled between the first antenna terminal and the first power amplifier, the first filter having a pass band that includes the first band;
a second filter coupled between the first antenna terminal or the second antenna terminal and the first low-noise amplifier, the second filter having a pass band that includes the second band; and
a third filter coupled between the second antenna terminal and the second power amplifier, the third filter having a pass band that includes the third band.
<5>

The radio-frequency module according to <3> or <4>, further comprising:
a first switch coupled between the first antenna terminal and the second antenna terminal, and the first power amplifier, the second power amplifier, and the first low-noise amplifier.
<6>

The radio-frequency module according to any of <1> to <5>, wherein
the IMD suppression circuit includes
   a first terminal coupled to the first power amplifier, a second terminal coupled to the second power amplifier, and a third terminal coupled to the first low-noise amplifier,
   a first amplitude adjustment circuit coupled to the first terminal,
   a second amplitude adjustment circuit coupled to the second terminal,
   a first phase adjustment circuit coupled to the first amplitude adjustment circuit,
   a second phase adjustment circuit coupled to the second amplitude adjustment circuit, and
   an IMD signal generation circuit coupled to the first phase adjustment circuit and the second phase adjustment circuit, the IMD signal generation circuit being configured to generate the IMD suppression signal.
<7>

The radio-frequency module according to <6>, wherein
the IMD suppression circuit further includes
   a fourth terminal and a fifth terminal,
   a second switch coupled between the first terminal and the fourth terminal, and the first amplitude adjustment circuit, the second switch being configured to switch connection of the first amplitude adjustment circuit between the first terminal and the fourth terminal, and
   a third switch coupled between the second terminal and the fifth terminal, and the second amplitude adjustment circuit, the third switch being configured to switch connection of the second amplitude adjustment circuit between the second terminal and the fifth terminal,
the fourth terminal is coupled to a third power amplifier,
the fifth terminal is coupled to a fourth power amplifier,
the IMD suppression circuit is configured to generate an IMD suppression signal that includes a frequency component of an unwanted signal of intermodulation distortion generated by simultaneous transfer of two transmit signals among a first transmit signal amplified by the first power amplifier, a second transmit signal amplified by the second power amplifier, a third transmit signal amplified by the third power amplifier, and a fourth transmit signal amplified by the fourth power amplifier.
<8>

The radio-frequency module according to <6> or <7>, further comprising:
a second low-noise amplifier, wherein
the IMD suppression circuit further includes
   a sixth terminal, and
   a fourth switch coupled between the third terminal and the sixth terminal, and the IMD signal generation circuit, the fourth switch being configured to switch connection of the IMD signal generation circuit between the third terminal and the sixth terminal,
the sixth terminal is coupled to the second low-noise amplifier, and
the IMD suppression circuit is configured to generate an IMD suppression signal that includes a frequency component of an unwanted signal of intermodulation distortion propagating through the first low-noise amplifier or the second low-noise amplifier, the IMD suppression signal having a phase different from the unwanted signal.
<9>

The radio-frequency module according to any of <6> to <8>, wherein
the IMD suppression circuit further includes
   a third amplitude adjustment circuit coupled between the IMD signal generation circuit and the third terminal.
<10>

The radio-frequency module according to any of <1> to <9>, further comprising:
a control circuit configured to control the IMD suppression circuit.
<11>

A communication device, comprising:
the radio-frequency module according to any of <1> to <10>; and
a radio-frequency (RF) signal processing circuit configured to process a radio-frequency signal received or to be transmitted by the radio-frequency module.

### INDUSTRIAL APPLICABILITY

The present disclosure can be used as a multi-band/multimode front-end module supporting Carrier Aggregation (CA) or Eutra NR Dual Connectivity (ENDC), in a wide variety of communication hardware, such as mobile phones.

### REFERENCE SIGNS LIST

1, 1A, 1B, 200 radio-frequency module
2a, 2b, 2c, 2d antenna
3 RF signal processing circuit (RFIC)
4, 4A, 4B communication device
11, 12, 13, 81, 82 power amplifier
21, 22, 23, 24, 25, 26, 91, 92 low-noise amplifier
31, 32, 33, 34, 35, 36, 37, 38, 39, 95, 96, 97, 98 filter
40, 40A, 41, 42, 43, 45 switch
50, 50A IMD suppression circuit
51, 52, 56 amplitude adjustment circuit
53, 54 phase adjustment circuit
55 IMD signal generation circuit
57, 58 frequency multiplier circuit
59 mixer
61, 62, 63, 65, 66 transmit path
71, 72, 73, 74, 75, 76, 77, 78 receive path
80 control circuit
101, 102, 103, 104 antenna connection terminal
111, 112, 115, 181, 182 signal input terminal
113, 114, 116, 117, 118, 119, 183, 184 signal output terminal
120 external connection terminal
130 control signal terminal
151, 152, 154, 155, 156, 157 input terminal
153, 158, 159, 160, 161, 162 output terminal

1. A radio-frequency module comprising:
a first power amplifier configured to amplify a signal of a first band;
a first low-noise amplifier configured to amplify a signal of a second band; and
an intermodulation distortion (IMD) suppression circuit coupled to the first power amplifier, a second power amplifier configured to amplify a signal of a third band, and the first low-noise amplifier, the IMD suppression circuit being configured to generate an IMD suppression signal that includes a frequency component of intermodulation distortion between the first band and the third band, wherein
the signal of the first band, the signal of the second band, and the signal of the third band are to be simultaneously transferred, and
the second band includes a frequency of the intermodulation distortion.

2. The radio-frequency module according to claim 1, wherein
the IMD suppression circuit is coupled to an input end of the first power amplifier, an input end of the second power amplifier, and an output end of the first low-noise amplifier.

3. The radio-frequency module according to claim 1, further comprising:
the second power amplifier; and
a first antenna terminal, a second antenna terminal, a first transmit input terminal, a second transmit input terminal, and a first receive output terminal, wherein
the first power amplifier is provided in a first transmit path connecting the first transmit input terminal and the first antenna terminal,
the second power amplifier is provided in a second transmit path connecting the second transmit input terminal and the second antenna terminal,
the first low-noise amplifier is provided in a first receive path connecting the first receive output terminal and the first antenna terminal or the second antenna terminal, and
the IMD suppression circuit is coupled to the first transmit path, the second transmit path, and the first receive path, and the IMD suppression circuit is configured to generate the IMD suppression signal that includes the frequency component of the intermodulation distortion, the IMD suppression signal having a phase different from an unwanted signal of the intermodulation distortion, the unwanted signal propagating through the first receive path.

4. The radio-frequency module according to claim 3, further comprising:
a first filter coupled between the first antenna terminal and the first power amplifier, the first filter having a pass band that includes the first band;
a second filter coupled between the first antenna terminal or the second antenna terminal and the first low-noise amplifier, the second filter having a pass band that includes the second band; and
a third filter coupled between the second antenna terminal and the second power amplifier, the third filter having a pass band that includes the third band.

5. The radio-frequency module according to claim 3, further comprising:
a first switch coupled between the first antenna terminal and the second antenna terminal, and the first power amplifier, the second power amplifier, and the first low-noise amplifier.

6. The radio-frequency module according to claim 1, wherein
the IMD suppression circuit includes
a first terminal coupled to the first power amplifier, a second terminal coupled to the second power amplifier, and a third terminal coupled to the first low-noise amplifier,
a first amplitude adjustment circuit coupled to the first terminal,
a second amplitude adjustment circuit coupled to the second terminal,
a first phase adjustment circuit coupled to the first amplitude adjustment circuit,
a second phase adjustment circuit coupled to the second amplitude adjustment circuit, and
an IMD signal generation circuit coupled to the first phase adjustment circuit and the second phase adjustment circuit, the IMD signal generation circuit being configured to generate the IMD suppression signal.

7. The radio-frequency module according to claim 6, wherein
the IMD suppression circuit further includes
a fourth terminal and a fifth terminal,
a second switch coupled between the first terminal and the fourth terminal, and the first amplitude adjustment circuit, the second switch being configured to switch connection of the first amplitude adjustment circuit between the first terminal and the fourth terminal, and
a third switch coupled between the second terminal and the fifth terminal, and the second amplitude adjustment circuit, the third switch being configured to switch connection of the second amplitude adjustment circuit between the second terminal and the fifth terminal,
the fourth terminal is coupled to a third power amplifier,
the fifth terminal is coupled to a fourth power amplifier, and
the IMD suppression circuit is configured to generate an IMD suppression signal that includes a frequency component of an unwanted signal of intermodulation distortion generated by simultaneous transfer of two transmit signals among a first transmit signal amplified by the first power amplifier, a second transmit signal amplified by the second power amplifier, a third transmit signal amplified by the third power amplifier, and a fourth transmit signal amplified by the fourth power amplifier.

8. The radio-frequency module according to claim 6, further comprising:
a second low-noise amplifier, wherein
the IMD suppression circuit further includes
a sixth terminal, and
a fourth switch coupled between the third terminal and the sixth terminal, and the IMD signal generation circuit, the fourth switch being configured to switch connection of the IMD signal generation circuit between the third terminal and the sixth terminal,
the sixth terminal is coupled to the second low-noise amplifier, and
the IMD suppression circuit is configured to generate an IMD suppression signal that includes a frequency component of an unwanted signal of intermodulation distortion propagating through the first low-noise amplifier or the second low-noise amplifier, the IMD suppression signal having a phase different from the unwanted signal.

9. The radio-frequency module according to claim 6, wherein
the IMD suppression circuit further includes
a third amplitude adjustment circuit coupled between the IMD signal generation circuit and the third terminal.

10. The radio-frequency module according to claim 1, further comprising:
a control circuit configured to control the IMD suppression circuit.

11. A communication device comprising:
the radio-frequency module according to claim 1; and
a radio-frequency (RF) signal processing circuit configured to process a radio-frequency signal received or to be transmitted by the radio-frequency module.

12. A communication device comprising:
the radio-frequency module according to claim 2; and
a radio-frequency (RF) signal processing circuit configured to process a radio-frequency signal received or to be transmitted by the radio-frequency module.

13. A communication device comprising:
the radio-frequency module according to claim 3; and
a radio-frequency (RF) signal processing circuit configured to process a radio-frequency signal received or to be transmitted by the radio-frequency module.

14. A communication device comprising:
the radio-frequency module according to claim 4; and
a radio-frequency (RF) signal processing circuit configured to process a radio-frequency signal received or to be transmitted by the radio-frequency module.

15. A communication device comprising:
the radio-frequency module according to claim 5; and
a radio-frequency (RF) signal processing circuit configured to process a radio-frequency signal received or to be transmitted by the radio-frequency module.

16. A communication device comprising:
the radio-frequency module according to claim 6; and
a radio-frequency (RF) signal processing circuit configured to process a radio-frequency signal received or to be transmitted by the radio-frequency module.

17. A communication device comprising:
the radio-frequency module according to claim 7; and
a radio-frequency (RF) signal processing circuit configured to process a radio-frequency signal received or to be transmitted by the radio-frequency module.

18. A communication device comprising:
the radio-frequency module according to claim 8; and
a radio-frequency (RF) signal processing circuit configured to process a radio-frequency signal received or to be transmitted by the radio-frequency module.

19. A communication device comprising:
the radio-frequency module according to claim 9; and
a radio-frequency (RF) signal processing circuit configured to process a radio-frequency signal received or to be transmitted by the radio-frequency module.

20. A communication device comprising:
the radio-frequency module according to claim 10; and
a radio-frequency (RF) signal processing circuit configured to process a radio-frequency signal received or to be transmitted by the radio-frequency module.
